(19) United States
(12) Patent Application Publication
(10) Pub. No.: US 2010/0064203 A1
(43) Pub. Date: Mar. 11, 2010

(54) METHOD FOR MANAGING STORAGE APPARATUS, STORAGE APPARATUS AND STORAGE SYSTEM

(75) Inventor: Masami Aihara, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/498,532

(22) Filed: Jul. 7, 2009

(30) Foreign Application Priority Data
Sep. 9, 2008 (JP) 2008-230510

(51) Int. Cl. G06F 11/00

(52) U.S. Cl. 714/799; 714/E11.024

(57) ABSTRACT

A method for managing a storage apparatus includes acquiring error information for each of physical addresses assigned to a logical address, and managing the error information for each of the physical addresses.

### CROSS-REFERENCE TO RELATED APPLICATION

This application is based upon and claims the benefit of priority of the prior Japanese Patent Application No. 2008-230510, filed on Sep. 9, 2008, the entire contents of which are incorporated herein by reference.

### FIELD

A certain aspect of the embodiments discussed herein relates to a method for managing a storage apparatus, a storage apparatus, and a storage system.

### BACKGROUND

A conventional storage apparatus is designed so that one memory area (physical address) is assigned to one logical address (more specifically, logical block address: LBA) used by a host machine for read and write. The conventional storage apparatus is equipped with a function of predicting a failure that occurs in the storage apparatus. This kind of function is called SMART (Self-Monitoring Analysis and Reporting Technology) prescribed by the T13 working group of ANSI. Such a failure predicting function, or SMART function is described in, for example, Japanese Laid-Open Patent Publication Nos. 2006-301853 and 2008-84168. The SMART function monitors and analyzes every information and signal that are output from the hard disk. When each attribute goes beyond a respective threshold value, the SMART function determines that a failure has occurred and alerts the host machine.

Recently, there has been proposed a technique in which a plurality of physical addresses for one LBL specified by the host machine is prepared on the storage apparatus side, and data are redundantly retained to thus improve the reliability of data guarantee.

More particularly, a plurality of physical addresses are associated with one LBA. When an access to the LBA is requested by the host machine, an access to one of the plurality of physical addresses associated with the LBA is carried out in the storage apparatus. If a failure occurs in an access to one of the plurality of physical addresses, another one of the plurality of physical addresses associated with the same LBA is accessed. Thus, data can be guaranteed.

The above technique may be used for data security. One of the plurality of physical addresses associated with one LBA is defined as a specific physical address common to all of the users, and the remaining physical addresses are defined as physical addresses that need users' authentication. Each user accesses the same storage apparatus on the LBA base. However, each user is not allowed to share data of the other users stored in the storage apparatus. Thus, the data security can be improved.

It is being considered that the SMART function is applied to the storage apparatus designed to associate one LBA with the multiple physical addresses. However, at present, it is difficult to certainly predict a failure and to efficiently cope with a failure.

More particularly, the SMART function is capable of only predicting a failure on the LBA base. Thus, it is impossible to understand which data is affected by the failure and which user is affected by the failure. In order to avoid the predicted failure, it is necessary to replace all of the physical addresses associated with the LBA at which the failure is predicted with other physical addresses. Thus, even physical addresses that are not faulty are replaced.

### SUMMARY

According to an aspect of the present invention, there is provided a method for managing a storage apparatus, including: acquiring error information for each of physical addresses assigned to a logical address; and managing the error information for each of the physical addresses.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a storage system in accordance with a first embodiment;

FIG. 2 schematically illustrates addresses processed in a host machine and a storage apparatus;

FIG. 3 is a flowchart of a method for managing the storage apparatus;

FIG. 4 is a flowchart of a subroutine at step S26 illustrated in FIG. 3;

FIG. 5 illustrates an exemplary log created in the first embodiment;

FIG. 6 illustrates a table of a degree of damage and a process depending on the degree of damage;

FIG. 7 is a flowchart of a process for sending a log in accordance with a second embodiment;

FIG. 8 is a flowchart of a process for receiving a long at the host machine;

FIG. 9 illustrates a third embodiment;

FIG. 10 is a block diagram of a storage system in accordance with a third embodiment;

FIG. 11 schematically illustrates addresses processed in the host machine and the storage apparatus; and

FIG. 12 illustrates an exemplary log created in the third embodiment.

### DESCRIPTION OF EMBODIMENTS

### First Embodiment

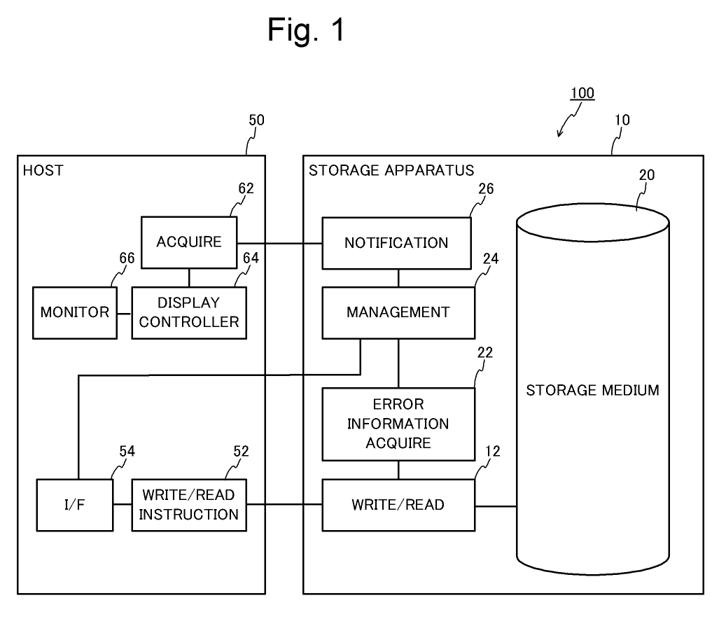

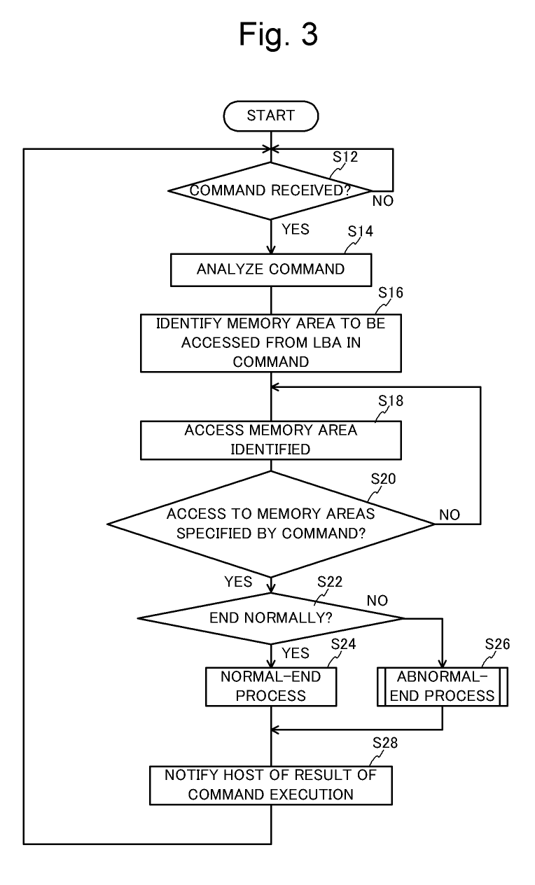

A storage system in accordance with a first embodiment will now be described with reference to FIGS. 1 through 6.

FIG. 1 is a block diagram of a structure of a storage system 100 in accordance with the first embodiment. As illustrated in FIG. 1, the storage system 100 includes a host machine 50 and a storage apparatus 10 connected to the host machine 50. The host machine 50 may be a personal computer or the like. The storage apparatus 10 may be a hard disk drive.

The storage apparatus 10 includes a storage medium 20, a write/read unit 12, an error information acquiring unit 22, a management unit 24 and a notification unit 26. The storage medium 20 may be a magnetic disk or magnetic disks. The write/read unit 12 includes a magnetic head (write/read element), and writes and read data in and from storage areas in the storage medium 20 specified by physical addresses associated with an LBA (logical address) designated in a command supplied from the host machine 50. The error information acquiring unit 22 has the SMART function prescribed by the T13 working group of ANSI. The unit 22 acquires error information on the storage medium 20 obtainable during writing and reading, and holds threshold values regarding error. The management unit 24 manages the error information acquired by the error information acquiring unit 22. The notification unit 26 notifies the host machine 50 of the error information (log data) managed by the management unit 24. The error information acquiring unit 22, the management unit 24 and the notification unit 26 will be described in more detail later.

The host machine 50 includes an input interface (I/F) 54, a write/read instruction unit 52, an acquiring unit 62, and a display controller 64. The input interface 54 includes a keyboard and a mouse, and is used to input a data write/read instruction by the user. The read/write instruction unit 52 receives the input via the input interface 54, and sends a read/write command to the storage apparatus 10 on the LBA base. The acquiring unit 62 receives error information (log data) given by the notification unit 26 of the storage apparatus 10. The display controller 64 causes error information to be displayed on a monitor 66.

The host computer 50 may be configured by combining a plurality of hardware devices (which correspond to the individual blocks in FIG. 1) or by a computer system including a CPU, a ROM and a RAM. The blocks illustrated in FIG. 1 may be functionally implemented by programs embedded in the computer system.

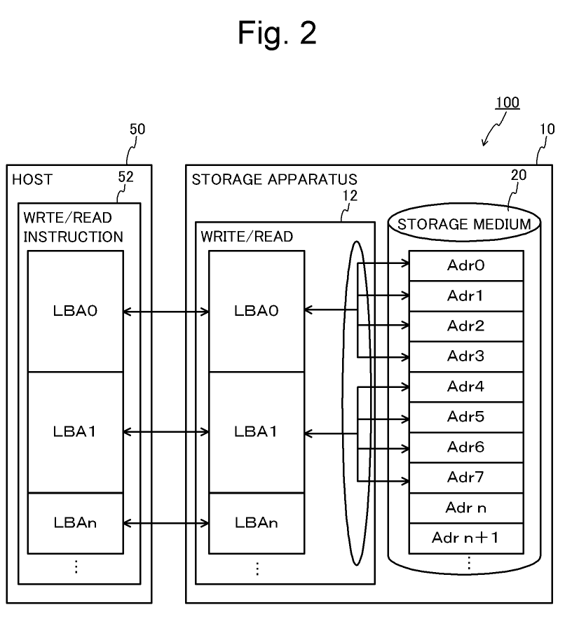

A description will now be given, with reference to FIGS. 2 through 4, of management of the storage apparatus 10 of the storage system 100. This management is carried out mainly by the error information acquiring unit 22, the management unit 24 and the notification unit 26 on the basis of the results of writing or reading by the write/read unit 12.

FIG. 2 schematically illustrates addresses (logical addresses and physical addresses) handled by the write/read instruction unit 52, the write/read unit 12 and the recording medium 20. The write/read instruction unit 52 supplies the write/read unit 12 with a command on the LBA base. The write/read unit 12 converts the LBA into the physical addresses (Adr) respectively associated with the storage areas of the storage medium 20. The write/read unit 12 writes and reads data into and from the storage areas. FIG. 2 illustrates an exemplary configuration in which four physical addresses are associated with one LBA (the degree of multiplexing or the number of physical addresses multiplexed is four). The physical addresses are assigned unique multiplexing numbers, which may be serial numbers.

In the management of the storage apparatus 10, the write/read unit 12 waits for a command from the write/read instruction unit 52 at step S12. The write/read unit 12 executes step S14 upon receiving a command.

At step S14, the write/read unit 12 analyzes the received command, and identifies the memory areas (physical addresses) of the storage medium 20 to be accessed on the basis of the LBA information defined in the analyzed command. For example, when the LBA information is LBA1, the write/read unit 12 identifies at least one of the physical addresses associated with LBA1. For example, the physical address Adr4 that has the smallest multiplexing number (order) is identified. Further, according to the present embodiment, another one of the four physical addressees associated with LBA1 is identified in order to improve the reliability of data guarantee. For example, the physical address Adr5 that has the second smallest multiplexing number is identified to store data.

At step S18, the write/read unit 12 accesses the storage medium 20, and writes or reads data in and from the memory areas specified by the two physical addresses.

At step S20, the write/read unit 12 determines whether the access to the memory areas specified by the command is completed. When the answer of step S20 is NO, that is, when the access to the specified memory areas is incomplete, the write/read unit 12 returns to step S18, and access a memory area that has not yet been accessed. When all of the memory areas specified by the command are completed, the process proceeds to step S22.

At step S22, the error information acquiring unit 22 determines whether the process of step S18 to all the storage areas is completed without any error. When the answer of step S22 is YES, the error information acquiring unit 22 executes a normal-end process, and notifies the host machine 50 (write/read instruction unit 52) of the result of command execution (normal end) at step S28.

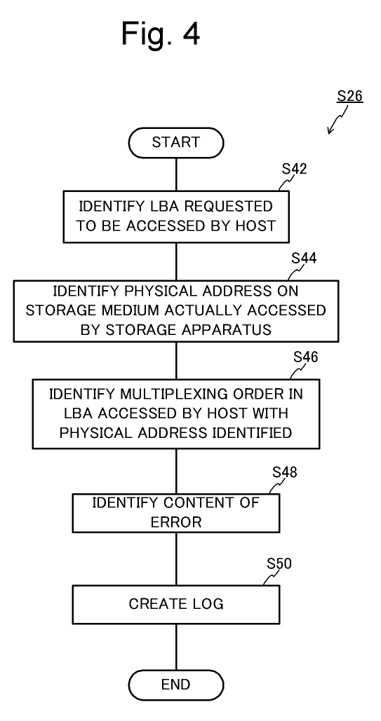

In contrast, when the answer of step S22 is NO, the error information acquiring unit 22 executes an abnormal-end-process subroutine at step S26. In the abnormal end process, the error information acquiring unit 22 identifies LBA requested to be accessed by the host machine 50 at step S42 illustrated in FIG. 4. Next, the error information acquiring unit 22 identifies the physical address requested to be accessed by the storage apparatus 10.

At step S46, the error information acquiring unit 22 identifies the multiplexing number of the physical address that is one of the physical addresses associated with the LBA accessed by the host machine 50. At step S48, the error information acquiring unit 22 identifies the content of the error.

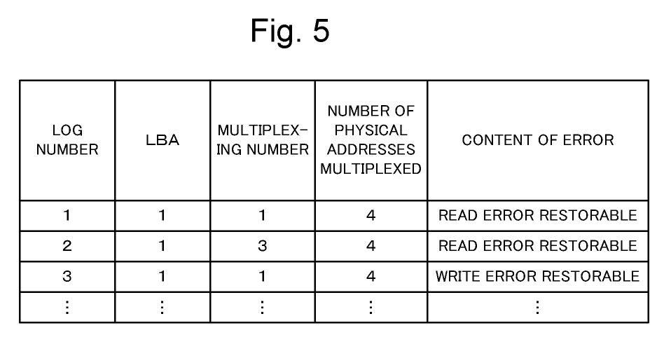

The error information acquiring unit 22 sends the position and content of the error to the management unit 24, which creates a log based on the received information. An exemplary log is illustrated in FIG. 5. The log includes items of “log number”, “LBA”, “multiplexing number”, “number of physical addresses multiplexed”, and “content of error”. The item of “log number” is a serial number assigned to each error information. The item of “LBA” is LBA specified by the command. The item of “multiplexing number” is the multiplexing number of the physical address involved in writing or reading. The item of “number of physical addresses multiplexed” indicates the number of physical addresses multiplexed in association with one LBA. The item of “content of error” indicates the detailed content of the error, which may describe whether the original can be recovered from the error, and whether the error is a write error or a read error. The log depicted in FIG. 5 shows that there is a restorable read error at physical address Adr0 for log number 1. For log number 2, there is a restorable read error at physical address Adr6. For log number 3, there is a restorable write error at physical address Adr0.

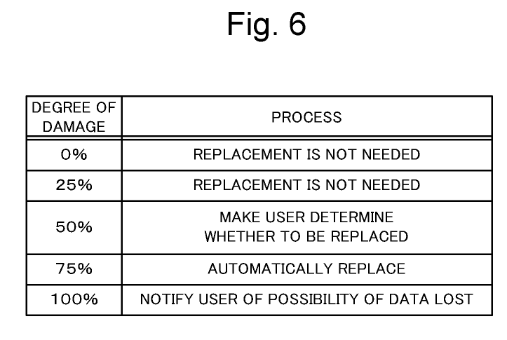

The log thus created is managed by the management unit 24, which executes various processes on the basis of the log and a table illustrated in FIG. 6.

The management unit 24 calculates the degree of damage for each LBA on the basis of the contents of the log illustrated in FIG. 5. The degree of damage denotes the frequency of occurrence of error for the same LBA, and is defined by expression (1) described below:

D[%]=(N/M)×100 (1)

Where D is the degree of damage, N is the number of multiplexing numbers having different numerals for which an error occurs, and M is the number of physical addresses multiplexed.

For log numbers 1 through 3 in FIG. 5, an error occurs in two multiplexing numbers of 1 and 3 for LBA1. Thus, D=(2/4)×100=50%.

The management unit 24 carries out a process associated with the degree of damage by referring to the table illustrated in FIG. 6. For a degree of damage of 0% or 25%, all or most of the four physical addresses associated with one LBA are usable in writing and reading without any problem, and these physical addresses are not replaced. The replacing of physical addresses releases the current association of the physical addresses with the LBA and associates other physical addresses with the present LBA.

For a degree of damage of 50%, the management unit 24 causes a message to be displayed on the monitor 66 the notification unit 26, the acquiring unit 62 and the display controller 64. The message urges the user to make a decision as to whether the physical addresses should be replaced. The decision made by the user is applied to the management unit 24 through the input interface 54. When the management unit 24 is notified of the replacement of the physical addresses requested by the user, the management unit 24 replaces the current physical addresses with other ones.

For a degree of damage of 75%, the management unit 24 automatically replaces the current physical addresses with other physical addresses.

For a degree of damage of 100%, data cannot be written in each of the memory areas specified by the respective physical addresses associated with one LBA, and the management unit 24 notifies the user of a possibility that data may be lost without replacement of physical addresses.

The management unit 24 executes an appropriate one of the different processes on the basis of the degree of damage.

As described above, the first embodiment acquires error information for each of the physical addresses associated with one LBA, and manages the error information thus acquired on the physical address base. It is thus possible to realize the replacement of physical address on the physical address base. By replacing only the physical address at which an error occurs with another physical address, it is possible to efficiently utilize the memory areas of the storage apparatus 10, as compared to the case where the acquiring of the error information and replacement of physical address are carried out on the logical address base.

According to the first embodiment, the degree of damage (the degree of occurrence of error within the same LBA) is calculated using expression (1), and the management is carried out for each physical address. It is thus possible to appropriately manage the physical addresses on the basis of the degree of damage for LBA.

According to the first embodiment, the physical addresses are managed with the number of physical addresses multiplexed in association with one LBA, and the multiplexing number indicative of the order of the physical address in the logical address. It is thus easy to efficiently manage many physical addresses. In addition, the degree of occurrence of error within the same LBA is managed on the physical address base, and is defined as the degree of damage that indicates the ratio of the number of physical addresses at which an error occurs to the number of physical addresses multiplexed in association with one LBA. It is thus possible to easily identify the damage precisely.

The first embodiment manages the physical addresses by using the multiplexing number and the number of physical addresses multiplexed. The first embodiment is not limited to the above, but may be configured by using the physical addresses themselves. Even in this variation, the degree of damage may be calculated by the ratio of the number of physical addresses at which an error occurs to the number of physical addresses multiplexed in association with one LBA. The first embodiment may be varied so as to manage the physical addresses by using an index or item other than the multiplexing number and the number of physical addresses multiplexed.

The first embodiment is not limited to the allocation of four physical addresses to one LBA but may be configured to associate an arbitrary number of physical addresses with one LBA.

### Second Embodiment

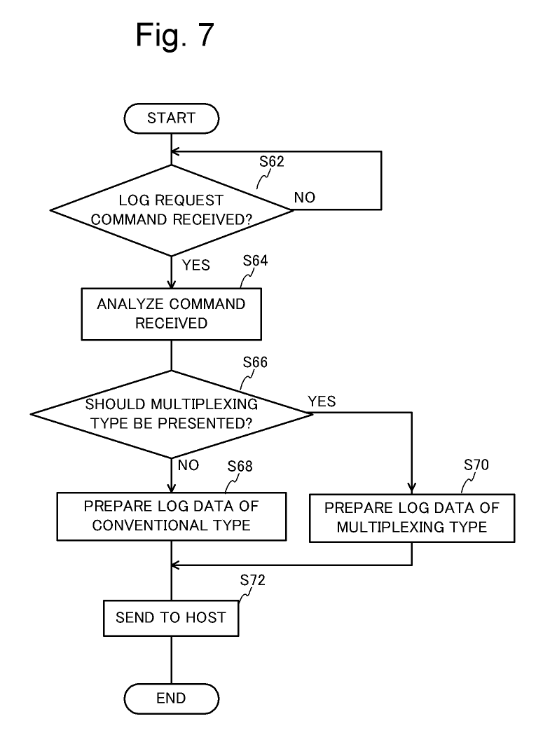

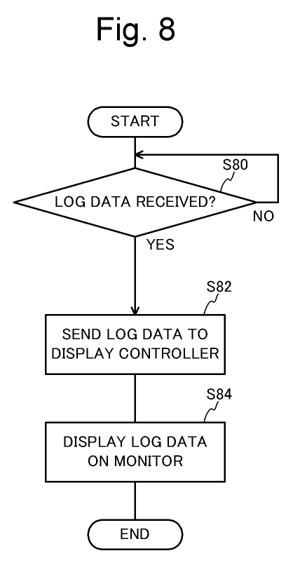

A second embodiment will now be described with reference to FIGS. 7 and 8. The second embodiment creates the log on the physical address base like the first embodiment, and additionally creates another log on the LBA base, which may not include the items of “multiplexing number” and “number of physical addresses multiplexed” employed in the log illustrated in FIG. 5. The user can receive the two different types of logs.

The two different types of logs are presented to the user in accordance with a sequence described in a flowchart of FIG. 7.

At step S62, the management unit 24 waits for a log request command that is inputted by the user via the input interface 54. The log request command instructs the management unit 24 to present the logs to the host 50.

At step S64, upon receiving the log request command, the management unit 24 analyzes the log request command received at step S62. At subsequent step S66, the management unit 24 determines whether the log of the multiplexing type (physical address base should be presented.

When the answer of step S66 is NO, the management unit 24 makes ready to send the log of the conventional type (logical address base) to the host machine 50. In contrast, when the answer of step S66 is YES, the management unit 24 makes ready to send the log of the multiplexing type to the host machine 50.

At step S72, the notification unit 26 sends the log prepared at step S68 or S70 to the acquiring unit 62 of the host machine 50 and ends the process of the flowchart of FIG. 7.

FIG. 8 is a flowchart of a process for receiving the log at the host machine 50. At step S80, the acquires 60 waits for the log from the notification unit 26. Upon receiving the log, the acquiring unit 62 sends the log data to the display controller 64 at step S82. The display controller 64 causes the log to be displayed on the monitor 66 at step 64.

As described above, either the log of the physical address base or the log of the logical address is presented in accordance with the user's request.

In the above-mentioned second embodiment, the log request command is issued in response to the request by the user. The second embodiment may be varied so that the log request command is issued to the storage apparatus 10 simultaneously when the host machine 50 is activated (each time the host machine 50 is activated). The user may select the log type beforehand.

In the above-mentioned second embodiment, the log itself is displayed on the monitor 66 under the control of the display controller 64. This may be varied so that a process to be done by the user (see FIG. 6) obtained from the log may be displayed on the monitor 66. The process to be done may be extracted from the log by the display controller 64, or may be extracted from the log by the management unit 24 and sent to the host machine 50 via the notification unit 26.

### Third Embodiment

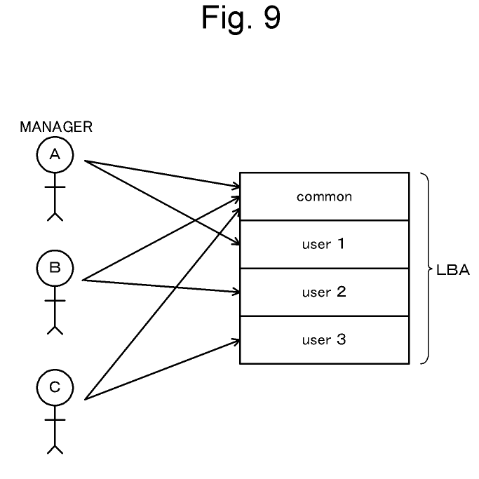

A third embodiment will now be described with reference to FIGS. 9 through 12. The third embodiment is configured to consider the security in a case where a plurality of users share one storage apparatus 10.

In the third embodiment, it is now assumed that there are three users A, B and C, and user A is appointed as a manager, as depicted in FIG. 9.

In the third embodiment, four physical addresses are associated with one LBA. Further, the following are assumed. One of the four physical addresses that has the smallest multiplexing number is defined as a physical address (common) that can be used by any of the three users A, B and C without any authentication. Another one of the four physical addresses that has the second smallest multiplexing number is defined as a physical address (user 1) assigned to the user A with authentication being needed. Yet another one of the four physical addresses that has the third smallest multiplexing number is defined as a physical address (user 2) assigned to the user B with authentication being needed. The last one of the four physical addresses that has the greatest multiplexing number is defined as a physical address (user 3) assigned to the user C with authentication being needed.

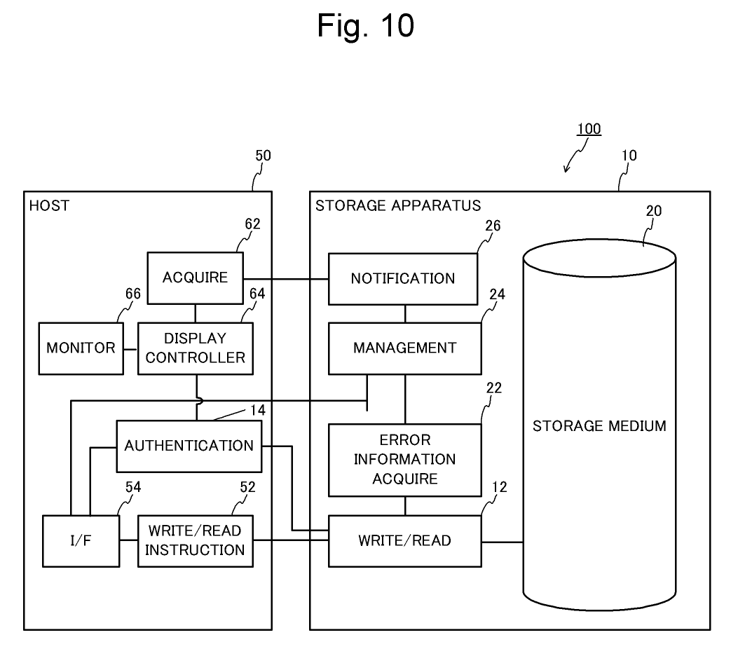

As illustrated in FIG. 10, the third embodiment is configured so that the host machine 50 has the authentication unit 14. The authentication unit 14 urges the user to input the user ID and password, and authenticates the user by referring to the user ID and password applied through the input interface 54.

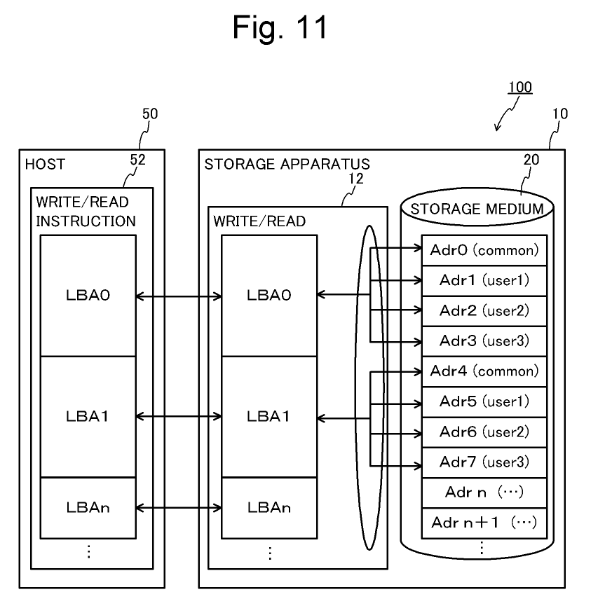

The result of authentication is sent to the write/read unit 12. As illustrated in FIG. 11, the write/read unit 12 converts the LBA into any of the physical addresses “common”, “user 1”, “user 2” and “user 3”, and writes or reads data in or from the memory area specified by the converted physical address. More particularly, when authentication is not performed by anybody, the write/read unit 12 converts the LBA into the physical address “common”. When authentication is performed by any of the uses A, B and C, the write/read unit 12 converts the LBA into any of physical addresses “user 1”, “user 2” and “user 3”. Then, the write/read unit 12 writes or reads data in or from the memory area specified by the converted physical address.

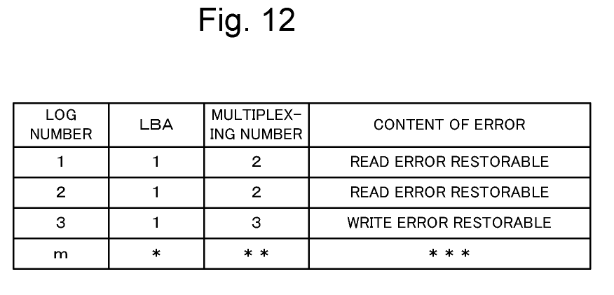

The management unit 24 of the third embodiment acquires a log as illustrated in FIG. 12. The log in FIG. 12 has items of “log number”, “LBA”, “multiplexing number”, and “content of error”.

The display controller 64 reads the multiplexing number at which an error occurs, and causes the content of the error to be displayed to the user related to the present multiplexing number (all of the users for a multiplexing number of 1, user A for 2, B for 3 and C for 4). That is, the content of the error is displayed only when the user is authenticated by the host machine 50.

When one of the users is appointed as a manager (user A in the present embodiment), as illustrated in FIG. 9, the display controller 64 notifies the user corresponding to the multiplexing number of the content of the error, and additionally notifies the manager (user A) of the content of the error.

With the above-described display, the replacement of physical address can be carried out on the physical address base as in the case of the first embodiment, and the storage medium 20 can be used efficiently. Further, information on one user can be hidden to other users by specifying the physical address involved in occurrence of error by the multiplexing number and setting the user to which the content of the error is displayed by referring to the specified multiplexing number.

The third embodiment may be varied so that the content of the error is displayed to all of the users rather than only the user corresponding to the multiplexing number. The third embodiment may be varied so that the content of the error is displayed to only the user corresponding to the multiplexing number without the manager. It is also possible to display the content of the error to only the manager.

The third embodiment employs the physical address “common” accessible by all the users. The third embodiment may be varied so that the physical address “common” is deleted and only the physical addresses respectively assigned to the individual users are used.

The number of users is not limited to three, but an arbitrary number of users can be handled similarly. Of course, multiple physical addresses equal in number to the users or more should be prepared for one LBA.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A method for managing a storage apparatus, comprising:
acquiring error information for each of physical addresses assigned to a logical address; and
managing the error information for each of the physical addresses.

2. The method according to claim 1, wherein the managing the error information includes managing the error information with a number of physical addresses assigned to one logical address and a multiplexing number that is unique to each of the physical addresses assigned to the one logical address.

3. The method according to claim 1, wherein the managing the error information includes calculating a degree of occurrence of error that is defined as a ratio of a number of physical addresses at which error occurs to a number of physical addresses assigned to one physical address.

4. The method according to claim 3, wherein the managing the error information includes determining whether the physical addresses at which error occurs should be replaced with other physical address on the basis of the degree of occurrence of error.

5. The method according to claim 3, wherein the managing the error information includes urging a user to make a decision as to whether the physical addresses at which error occurs should be replaced with other physical addresses on the basis of the degree of occurrence of error.

6. The method according to claim 3, wherein the managing the error information includes notifying a user of a possibility that data accessible by the logical address may be deleted on the basis of the degree of occurrence of error.

7. The method according to claim 2, wherein an accessible user is defined for each multiplexing number, and the managing the error information includes determining users to be notified of occurrence of error on the multiplexing number of each of physical addresses at which error occurs.

8. The method according to claim 7, wherein the managing the error information includes notifying a specific user appointed as a manager of occurrence of error irrespective of the multiplexing number of each of physical addresses at which error occurs.

9. A storage apparatus comprising:
a first part configured to acquire error information for each of physical addresses assigned to a logical address; and
a second part configured to manage the error information for each of the physical addresses.

10. The storage apparatus according to claim 9, wherein the second part manages the error information with a number of physical addresses assigned to one logical address and a multiplexing number that is unique to each of the physical addresses assigned to the one logical address.

11. The storage apparatus according to claim 9, further comprising a notification part that notifies an external part of the error information managed by the second part.

12. A storage system comprising:
a host; and
a storage apparatus connected to the host and operated to write and read data in and from a storage medium,
the storage apparatus including:
a first part configured to acquire error information for each of physical addresses assigned to a logical address; and
a second part configured to manage the error information for each of the physical addresses.
